(19) United States
(12) Patent Application Publication
(10) Pub. No.: US 2006/0029724 A1
(43) Pub. Date: Feb. 9, 2006

(54) System for jetting phosphor for optical displays

(75) Inventors: Alec J. Babiarz, Encinitas, CA (US); Alan R. Lewis, Carlsbad, CA (US); Yosuke Sagami, Kawasaki (JP); Floriana Suriawidjaja, Carlsbad, CA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation

(21) Appl. No.: 10/913,229

(22) Filed: Aug. 6, 2004

(51) Int. Cl. B05D 5/12; B05D 5/06; B05C 11/00

(52) U.S. Cl. 427/64; 427/8; 118/688; 118/665

(57) ABSTRACT

A jetting system has a jetting dispenser mounted for relative motion with respect to a plasma panel. A control is operable to cause the jetting dispenser to jet a phosphor droplet that is applied to a cell of the panel. A feedback signal indicative of the placement and size of the dot is communicated to a control. The size, velocity offset and/or placement of subsequently applied phosphor dots is controlled by heating and cooling, or adjusting a piston stroke in the jetting dispenser in response to the feedback.

### FIELD OF THE INVENTION

The present invention generally relates to light emitting panels, and more particularly, to methods and equipment used to fabricate the same.

### BACKGROUND OF THE INVENTION

Plasma screens produce glare-free color images with exceptional resolution, despite having relatively large and compact displays. The desirable display features of plasma screens are attributable to their unique construction, which typically comprises two glass panels that sandwich a grid of plasma cells. The sealed cells contain rare gases, e.g., argon, neon or xenon, in addition to red, green and blue phosphors. Electrodes positioned within the glass panels ionize the gas to form plasma. Ultraviolet light produced by the plasma reacts with the colored phosphors to produce visible light in the form of reconstituted video images.

Conventional methods used for forming the light emitting phosphor layers include screen printing technologies. In screen printing, a screen mesh is emulsed with phosphor pastes consisting of phosphor powder and a binder resin. The mesh has openings that correspond to the position of plasma cells between adjacent barrier ribs of a plasma panel. The phosphor pastes are transferred through the screen mesh at the portions requiring the phosphor pastes, i.e., the spaces between the respectively adjacent barrier grid, or ribs. Sandblasting is sometimes used after the screen printing, and the phosphor is often coated with a cross-linking agent.

While meeting with some success, screen printing methods remain limited in that the mesh becomes deformed as a result of repeated printing during manufacture. This technique can thus be expensive, in that mesh must frequently be exchanged during production. Moreover, the accuracy of the emulsion techniques used by screen printing is problematic, resulting in bridging between plasma cells. These disadvantages make it difficult to form an economically feasible phosphor layer that is capable of providing a highly precise plasma display.

Another method of placing phosphors within cells of a plasma panel involves coating ribs with phosphor pastes. The resultant film of paste is consequently exposed with ultraviolet light using a photomask to form portions of film that are soluble in a developer. Undesired paste is then washed away from the remaining panel. This method must be repeated for each layer of red, green and blue phosphor, however, which complicates the processes of coating, exposure, development, drying, etc. The method also has a disadvantage that large amounts of phosphor pastes are wasted during manufacture, raising costs.

As part of another technique, phosphor paste is ejected from the tip of an ink jet nozzle to form a phosphor layer. However, this method must keep the paste viscosity at 0.2 poise or less since the paste must be ejected from the tip of an ink jet nozzle with a small diameter. Since the amount of the phosphor powder in the paste cannot be increased, the thickness of the phosphor layer cannot be controlled advantageously. Furthermore, the ink jet nozzle is often clogged by the phosphor powder, resulting in wasted product. Conventional ink jet technology further lacks the ability to precisely control the amount of phosphor sprayed into cells, and requires an economically unfeasible amount of time to fill the millions of cells implicated in a typical plasma panel further.

There is consequently a need for an improved method for applying light emitting material to a plasma panel that addresses the needs described above.

### SUMMARY OF THE INVENTION

The present invention provides an improved method of distributing phosphor onto a plasma screen. An embodiment includes a noncontact jetting system that accurately applies, on-the-fly, a viscous phosphor dot into a plasma cell of the screen. The system permits dispensed weight or dot size of the applied phosphor to be adjusted by changing either the temperature of the nozzle or the stroke of a piston in the jetting valve. This provides a simpler and less expensive system with a relatively fast response time for calibrating dispensed phosphor dot size. This feature thus helps ensure that the desired amount of phosphor, or other light emitting related material is applied to the screen with increased accuracy and speed.

To this end, the noncontact jetting system permits a relative velocity between a nozzle and the plasma screen to be automatically optimized as a function of current phosphor dispensing characteristics and the volume of phosphor material, or dot size, applied to a respective cell. The result is a more precise application of the dispensed phosphor on the plasma screen. In addition, the jetting system optimizes placement of the phosphor dot within the respective cells of the plasma screen. That is, the phosphor dots are dispensed as a function of the relative velocity between the nozzle and the plasma panel so that dots dispensed on-the-fly are accurately applied to the cells.

The invention thus provides a viscous material noncontact jetting system with a jetting dispenser mounted for relative motion with respect to a plasma panel and/or a test substrate. A control is connected to the jetting dispenser and has a memory for storing a desired size-related physical characteristic of a dot of phosphor material. The control is operable to cause the jetting dispenser to apply a dot of the phosphor material within respective cells of the panel. A device is connected to the control and provides a feedback signal representing a detected size-related physical characteristic of the dot applied to the panel or substrate. A temperature controller has a first device for increasing the temperature of the nozzle and a second device for decreasing the temperature of the nozzle. The control is operable to cause the temperature controller to change a temperature of the nozzle in response to a difference between the detected size-related physical characteristic and the desired size-related physical characteristic.

The size-related physical characteristic is determinative of either a diameter or a weight of a phosphor dot applied to a respective cell. As such, a camera or a weigh scale may be used. Other aspects of this invention include methods of operating either a first device that increases the temperature of the nozzle or a second device that decreases the temperature of the nozzle in response to the difference between the detected size-related physical characteristic and the desired size-related physical characteristic.

In another embodiment of the invention, a control is operable to first cause a piston in the jetting dispenser to move through a stroke away from a seat and thereafter, cause the piston to move through the stroke toward the seat to jet a droplet of viscous phosphor through the nozzle. The droplet is applied to the plasma cell as a dot of viscous phosphor. The control is further operable to increase or decrease the stroke of the piston in response to the feedback signal representing a size-related physical characteristic of the dot that is respectively, less than or greater than the desired dot size value. In other aspects of this invention, methods are used to increase or decrease the stroke of the piston in response to the size-related physical characteristic of the dot applied to the surface being respectively, less than, or greater than, a desired value.

In yet another embodiment of the invention, the control is operable to cause the jetting dispenser to jet a phosphor droplet through the nozzle at a first location resulting in a dot of viscous phosphor being applied to the plasma cell, test substrate, or other surface. A camera connected to the control provides a feedback signal representing a location of a physical characteristic of the dot on a surface. The control determines a location of the dot on the surface, and determines an offset value representing a difference between the first location and the location of the dot on the surface. The offset value is stored in the control and is used to offset coordinate values representing the first location during a subsequent jetting of phosphor material.

Another aspect of the invention coordinates dispensing operations involving a plurality of jet nozzles involved in a common phosphor application process. For example, calibration processes align multiple nozzles of one or more jetting dispensers with respect to the plasma panel or other surface using rotational offset determinations. Where desired, the above calibration features are performed individually and in series for a plurality of nozzles jetting the phosphor onto the plasma panel. To this end, each jet of a plurality of jets may include an independent fluid regulator to compensate for mechanical differences of respective jets sharing a common phosphor supply reservoir.

These and other objects and advantages of the present invention will become more readily apparent during the following detailed description taken in conjunction with the drawings herein.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is plasma panel constructed in accordance with the principles of the present invention;

FIG. 2 is a schematic representation of a computer controlled, jetting system configured to apply phosphor to the plasma panel of FIG. 1;

FIG. 3 is a schematic block diagram of the computer controlled, noncontact jetting system of FIG. 2;

FIG. 4 is a flowchart generally illustrating a dispensing cycle of operation of the phosphor material jetting system of FIG. 2;

FIG. 5 is a flowchart generally illustrating a phosphor dot size calibration process using the jetting system of FIG. 2;

FIG. 6 is a flowchart generally illustrating an alternative embodiment of a dot size calibration process using the jetting system of FIG. 2;

FIG. 7 is a flowchart generally illustrating a further alternative embodiment of a dot size calibration process using the jetting system of FIG. 2;

FIG. 8 is a flowchart generally illustrating a dot placement calibration process using the jetting system of FIG. 2; and

FIG. 9 is a flowchart generally illustrating an alternative embodiment of a dot placement calibration process using the jetting system of FIG. 2;

FIG. 10 is a schematic representation of a computer controlled, jetting system similar to the system shown in FIG. 2 but having multiple jetting dispensers and nozzles.

### DETAILED DESCRIPTION

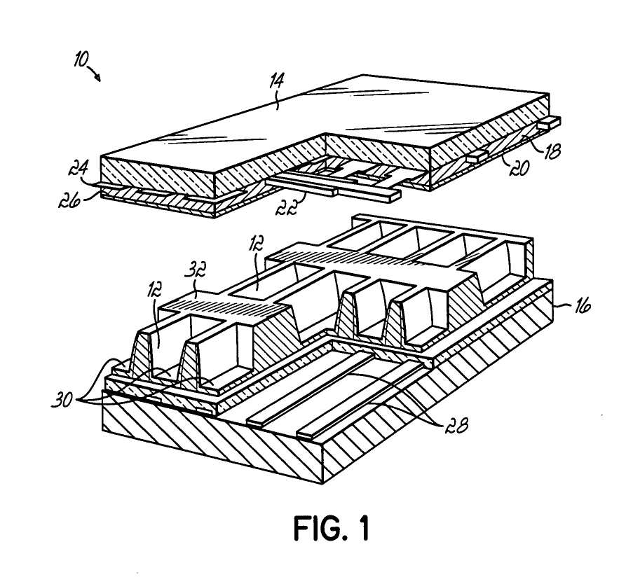

FIG. 1 is a plasma panel 10 having a network of plasma cells 12 located between a coplanar arrangement of front and rear plates 14 and 16, respectively. The front plate 14 comprises a glass substrate on which a dielectric layer 18 and thereon a protective layer 20 are provided. The protective layer 20 is typically made of MgO, and the dielectric layer 18 is made, for example, of glass containing PbO. Parallel, strip-type discharge electrodes 24 and auxiliary electrodes 22 are provided on the glass plate 14 and are covered by the dielectric layer 18. The electrodes 22 and 24 are typically made from metal. The dielectric layer 18 provided over the transparent discharge electrodes 24 prevents direct discharge between the electrodes 24, thus mitigating the formation of an arc or other undesired effect during ignition of the discharge.

In the panel embodiment shown in FIG. 1, an ultraviolet light emitting layer 26 is provided on the protective layer 20 and converts radiation into ultraviolet radiation with wavelength of 200 to 350 nm. The rear plate 16 is made of glass, and parallel, strip-type address electrodes 28, for example made of Ag, are provided on the carrier plate 16 so as to be selectively in electronic communication with the discharge electrodes 24. The address electrodes 28 are covered with phosphor layers 30 that emit light in one of the three basic colors red, green, or blue. The individual plasma cells are separated by separation ribs 32, preferably made of a dielectric material. As such, the barrier ribs 32 can be formed using various methods known in the art, e.g., by printing a pattern using a glass paste, laminating a dry film resist, sandblasting, and photolithography.

A gas, e.g., He, Ne, Xe, or Kr, is present in the plasma cell 12 between the discharge electrodes 24, pairs of which act alternately as the cathode and anode. After the surface discharge has been ignited, whereby charges can flow along a discharge path that lies between the discharge electrodes 24 in the plasma region 26, a plasma is formed in a plasma region 26 by means of which radiation is generated in the ultraviolet range. This radiation selectively excites the associated phosphor layer 30 into phosphorescence, thus emitting visible light through the front glass plate 14. The emitted light issues through the plate 14 in one of the three basic colors to form a luminous pixel on the plasma display screen.

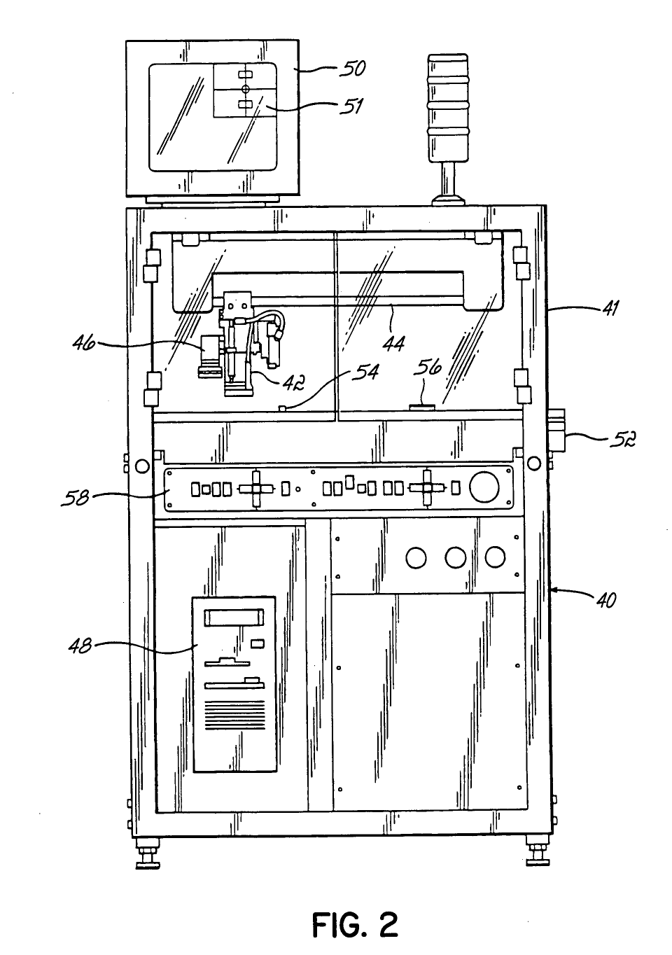

FIG. 2 is a schematic representation of a computer controlled viscous material noncontact jetting system 40 of the type commercially available from Asymtek of Carlsbad, Calif. A rectangular frame 41 is made of interconnected horizontal and vertical steel beams. A viscous material droplet generator 42 is mounted on a Z-axis drive that is suspended from an X-Y positioner 44 mounted to the underside of the top beams of the frame 41. The X-Y positioner 44 is operated by a pair of independently controllable motors (not shown) in a known manner. The X-Y positioner 44 and Z-axis drive provide three substantially perpendicular axes of motion for the droplet generator 42. A video camera and LED light ring assembly 46 may be connected to the droplet generator 42 for motion along the X, Y and Z axes to inspect dots and locate reference fiducial points. The video camera and light ring assembly 46 may be of the type described in U.S. Pat. No. 5,052,338 the entire disclosure of which is incorporated herein by reference.

A computer 48 is mounted in the lower portion of the frame 41 for providing the overall control for the system. The computer 48 may be a programmable logic controller (“PLC”) or other microprocessor based controller, a hardened personal computer or other conventional control devices capable of carrying out the functions described herein as will be understood by those of ordinary skill. A user interfaces with the computer 48 via a keyboard (not shown) and a video monitor 50. A commercially available video frame grabber in the computer causes a real time magnified image 51 of a cross-hair and dispensed dot to be displayed in a window on the monitor 50, surrounded by the text of the control software. The computer 48 may be provided with standard RS-232 and SMEMA CIM communications busses 80 that are compatible with most types of other automated equipment utilized in substrate production assembly lines.

Plasma panels, which are to have dots of phosphor applied to respective cells, are manually loaded or horizontally transported directly beneath the droplet generator 42 by an automatic conveyor 52. The conveyor 52 is of conventional design and has a width that can be adjusted to accept plasma panels of different dimensions. The conveyor 52 also includes pneumatically operated lift and lock mechanisms. This embodiment further includes a nozzle priming station 54 and a calibration station 56. A control panel 58 is mounted on the frame 41 just below the level of the conveyor 52 and includes a plurality of push buttons for manual initiation of certain functions during set-up, calibration and phosphor material loading.

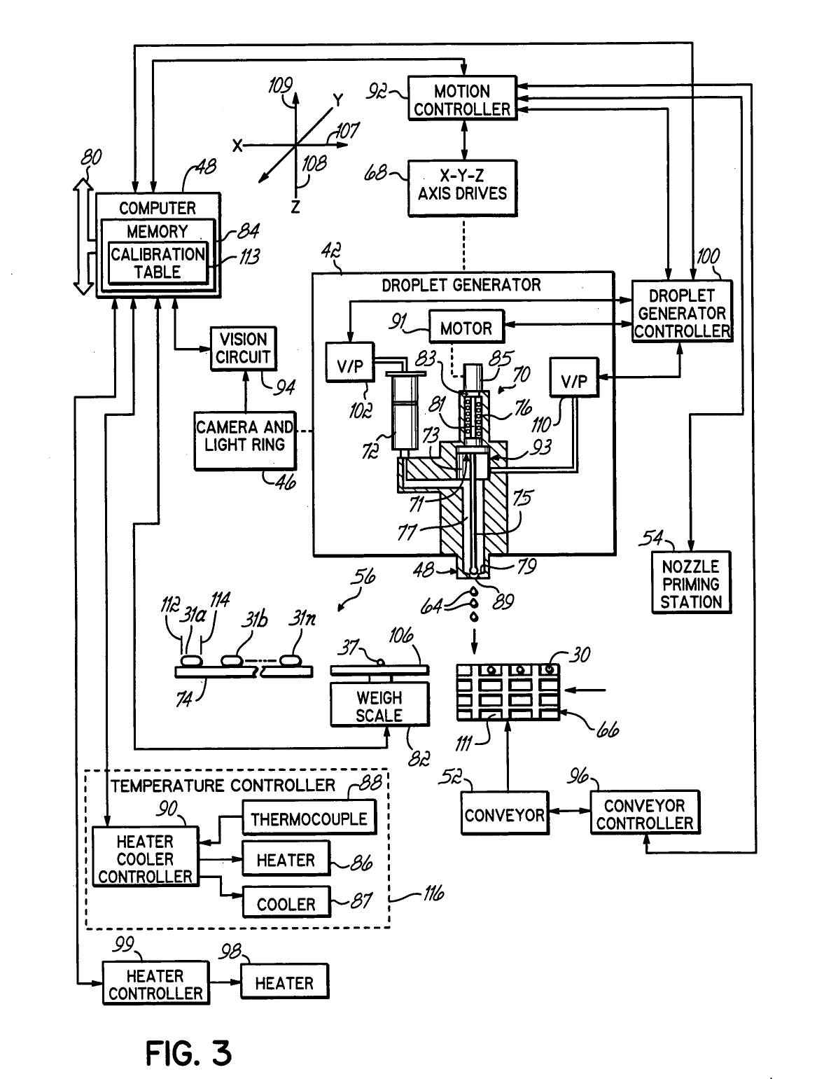

Referring to FIG. 3, the droplet generator 42 is shown jetting droplets 64 of phosphor material downwardly onto the upper surface 111 of a plasma panel 66. The plasma panel 66 is configured to receive a minute dot of phosphor material rapidly and accurately within each of its cells. The plasma panel 66 is moved to a desired position by the conveyor 52.

Axes drives 68 are capable of rapidly moving the droplet generator 42 over the surface of the plasma panel 66. The axes drives 68 include the electro-mechanical components of the X-Y positioner 44 and a Z-axis drive mechanism to provide X, Y and Z axes of motion 107, 108 and 109, respectively. Often, the droplet generator 42 jets droplets of viscous phosphor material from one fixed Z height. However, the droplet generator 42 can be raised using the Z-axis drive to dispense at other Z heights.

The droplet generator 42 includes an ON/OFF jetting dispenser 70, which is a non-contact dispenser specifically designed for jetting minute amounts of phosphor. The dispenser 70 may have a jetting valve with a piston 71 disposed in a cylinder 73. The piston 71 has a lower rod 75 extending therefrom through a material chamber 77. A distal lower end of the lower rod 75 is biased against a seat 79 by a return spring 76. The piston 71 further has an upper rod 81 extending therefrom with a distal upper end that is disposed adjacent a stop surface on the end of a screw 83 of a micrometer 85. Adjusting the micrometer screw 83 changes the upper limit of the stroke of the piston 71. The dispenser 70 may include a syringe-style supply device 72 that is fluidly connected to a supply of viscous material (not shown) in a known manner. A droplet generator controller 100 provides an output signal to a voltage-to-pressure transducer 102, for example, an air piloted fluid regulator, one or more pneumatic solenoids, etc., connected to a pressurized source of fluid, that, in turn, ports pressurized air to the supply device 72. Thus, the supply device 72 is able to supply pressurized viscous material to the chamber 77.

A jetting operation is initiated by the computer 48. The operation provides a command signal to the droplet generator controller 100 that causes the controller 100 to provide an output pulse to a voltage-to-pressure transducer 110, for example, an air piloted fluid regulator, one of more pneumatic solenoids, etc., connected to a pressurized source of phosphor. The pulsed operation of the transducer 110 ports a pulse of pressurized air into the cylinder 73 and produces a rapid lifting of the piston 71. Lifting the piston lower rod 75 from the seat 79 draws viscous phosphor material in the chamber 77 to a location between the piston lower rod 75 and the seat 79. At the end of the output pulse, the transducer 110 returns to its original state, thereby releasing the pressurized air in the cylinder 73, and a return spring 76 rapidly lowers the piston lower rod 75 back against the seat 79. In that process, a droplet 64 of phosphor material is rapidly extruded or jetted through an opening or dispensing orifice 89 of a nozzle 78.

As schematically shown in exaggerated form in FIG. 3, the viscous material droplet 64 breaks away as a result of its own forward momentum. The forward momentum carries the phosphor droplet 64 to the panel upper surface 111, where it is applied as a viscous material dot 30 that coats a respective cell. Rapid successive operations of the jetting valve provide respective jetted droplets 64 on the panel's upper surface 111. As used herein, the term “jetting” refers to the above-described process for forming viscous material droplets 64 and dots 30. The dispenser 70 is capable of jetting droplets 64 from the nozzle 78 at very high rates, for example, up to 100 or more droplets per second. A motor 91 controllable by the droplet generator controller 100 is mechanically coupled to the micrometer screw 83, thereby allowing the stroke of the piston 71 to be automatically adjusted, which varies the volume of viscous phosphor material in each jetted droplet. Jetting dispensers of the type described above are more fully described in U.S. Pat. Nos. 6,253,757 and 5,747,102, the entire disclosures of which are hereby incorporated herein by reference.

A motion controller 92 governs the motion of the droplet generator 42 and the camera and light ring assembly 46 connected thereto. The motion controller 92 is in electrical communication with the axes drives 68 and provides command signals to separate drive circuits for respective X, Y and Z axes motors in a known manner.

The camera and light ring assembly 46 is connected to a vision circuit 94. This circuit drives red LEDs of a light ring for illuminating the panel upper surface 111 and the dots 30 applied thereto. A video camera in the assembly 46 includes a charge coupled device (CCD) having an output that is converted to digital form and processed in determining both the location and size of a selected dot dispensed onto the plasma panel 66. A vision circuit 94 communicates with the computer 48 and to provide information thereto in both set-up and run modes.

A conveyor controller 96 is connected to the substrate conveyor 52. The conveyor controller 96 interfaces between the motion controller 92 and the conveyor 52 for controlling the width adjustment and lift and lock mechanisms of the conveyor 52. The conveyor controller 96 also controls the entry of the plasma panel 66 into the system and the departure therefrom upon completion of the viscous material deposition process. In some applications, a substrate heater 98 is operative in a known manner to heat the panel and maintain a desired temperature profile of the viscous material as the panel is conveyed through the system. The substrate heater 98 is operated by a heater controller 99 in a known manner.

The calibration station 56 is used for calibration purposes to provide dot size calibration for accurately controlling the weight, or size, of the dispensed dots 30. Dot placement calibration at the station 56 accurately locates viscous material dots that are dispensed on-the-fly, that is, while the droplet generator 42 is moving relative to the plasma panel 66. In addition, the calibration station 56 is used to provide a material volume calibration for accurately controlling the velocity of the droplet generator 42 as a function of current material dispensing characteristics and the rate at which the droplets are to be dispensed.

The calibration station 56 includes a stationary work surface 74 and a measuring device 82, for example, a weigh scale, that provides a feedback signal to the computer 48 representing a size related physical characteristic of the dispensed material, which in this embodiment is the weight of phosphor weighed by the scale 82. Weigh scale 82 is operatively connected to the computer 48, and the computer 48 compares the weight of the material with a previously determined specified value, for example, a viscous material weight set point value stored in a computer memory 84. Other types of devices may be substituted for the weigh scale and, for example, may include other dot size measurement devices such as vision systems, including cameras, LEDs or phototransistors for measuring the diameter, area and/or volume of the dispensed material.

In this embodiment, the noncontact jetting system 40 further includes a temperature controller 116 including a heater 86, a cooler 87 and a temperature sensor 88, for example, a thermocouple, an RTD device, etc., which are disposed immediately adjacent the nozzle 78. The heater 86 may be a resistance heater that provides heat to the nozzle 78 by radiance or convection. The cooler 87 can be any applicable device, for example, a source of cooler air, a vortex cooling generator that is connected to a source of pressurized air, etc. In other embodiments, a Peltier device may be used. The specific commercially available devices chosen to provide heating and cooling will vary depending several factors. Such factors include the environment in which the noncontact jetting system 40 is used, the viscous material being used, the heating and cooling requirements, the cost of the heating and cooling devices, the design of the system, for example, whether heat shields are used, and other application related parameters.

The thermocouple 88 provides a temperature feedback signal to a heater/cooler controller 90, and the controller 90 operates the heater 86 and cooler 87 in order to maintain the nozzle 78 at a desired temperature as represented by a temperature set point. The controller 90 is in electrical communication with the computer 48. Thus, the temperature of the nozzle 78 and the viscous material therein is accurately controlled while it is located in and being ejected from the nozzle 78, thereby providing a higher quality and more consistent dispensing process.

In the operation of one embodiment, CAD data from a disk or a computer integrated manufacturing (“CIM”) controller are utilized by the computer 48 to command the motion controller 92 to move the droplet generator 42. This ensures that the minute dots of viscous material are accurately placed on the plasma panel 66 at the desired locations. The computer 48 automatically assigns dot sizes to specific components based on the user specifications or a stored component library. In applications where CAD data is not available, the software utilized by the computer 48 allows for the locations of the dots to be directly programmed. In a known manner, the computer 48 utilizes the X and Y locations, the component types and the component orientations to determine where and how many phosphor dots to apply to the upper surface 111 of the plasma panel 66. The path for dispensing the minute phosphor droplets is optimized by aligning the in-line points. Prior to operation, a nozzle assembly is installed that is often of a known disposable type designed to eliminate air bubbles in the fluid flow path.

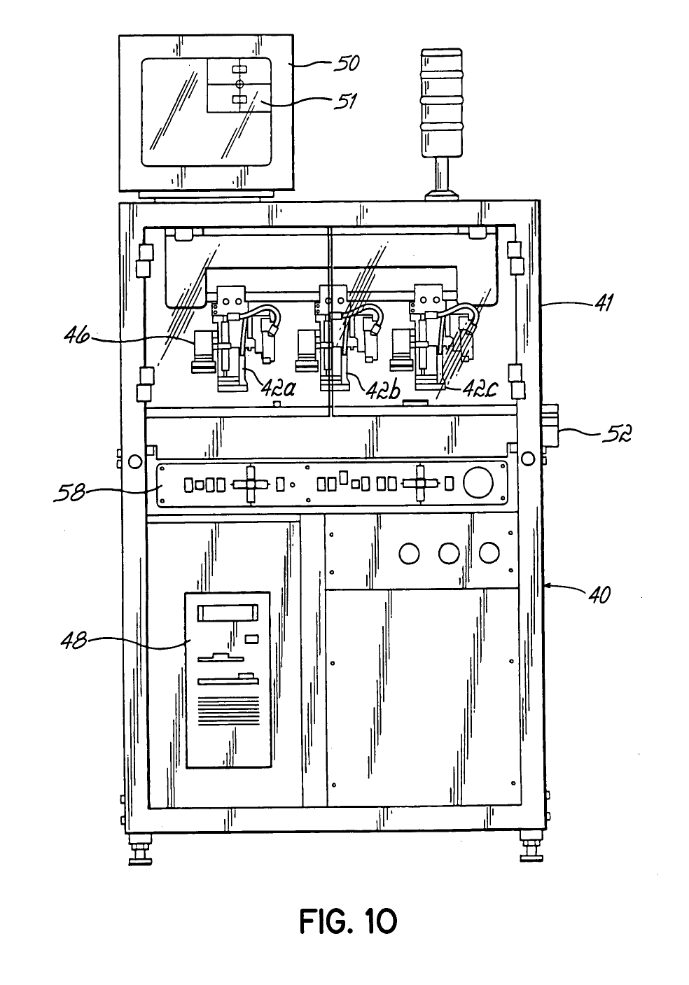

While only one jet nozzle is described in FIGS. 1-3, one skilled in the art will appreciate that the principles of the present invention apply equally to groups of jetting dispensers and/or nozzles used concurrently during a panel manufacturing processes. For instance, one skilled in the art will appreciate that ten jetting dispensers similar to that shown in FIGS. 1-3 may be aligned to apply phosphor to cells of a plasma panel. An embodiment having three such jets 42a, 42b and 42c is shown in FIG. 10. In another embodiment, a single jetting dispenser may have multiple, rotating nozzles configured to jet phosphor material. In either embodiment, the multiple nozzles may draw from a common, or separate phosphor reservoirs. As such, the nozzles may dispense different or the same color of phosphor per application specifications.

To this end, each jet typically includes an individual feed regulator to achieve pressure conformity as between different jets. This feature accounts for mechanical variations in equipment and helps to coordinate dispensing processes between nozzles. As discussed herein, other calibration processes may be included to align multiple nozzles of one or more jetting dispensers with respect to the plasma panel using rotational offset determinations. Where desired, the above calibration features are performed individually and in series for a plurality of nozzles jetting the phosphor onto the plasma panel.

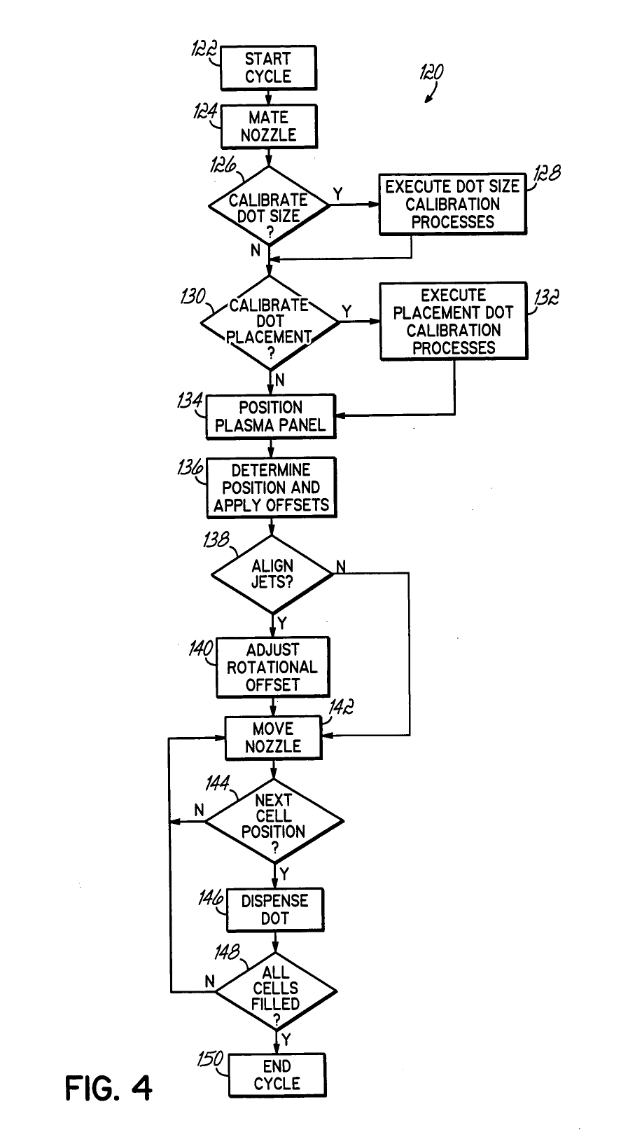

After all of the set up procedures have been completed, a user then utilizes the control panel 58 to provide a cycle start command to the computer 48. Referring to FIG. 4, the computer 48 then begins executing a dispensing cycle of operation. Turning more particularly to the flowchart 120 of FIG. 4, the computer 48 provides command signals to the motion controller 92 in response to receiving a start cycle indication at block 122. The command signals cause the droplet generator 42 to be moved to the nozzle priming station 54. The nozzle assembly is mated with a resilient priming boot at block 124 in a known manner at the priming station 54. Using an air cylinder (not shown), a vacuum is then pulled on the boot to suck viscous material from the pressurized syringe 72 and through the nozzle assembly.

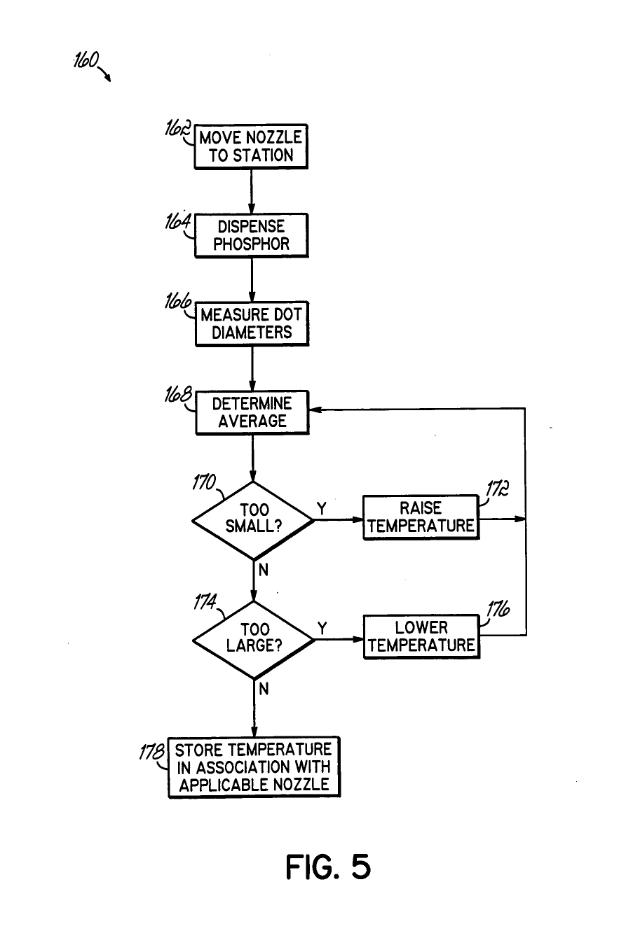

Thereafter, the computer 48 determines at block 126 whether a dot size calibration is required. A dot size calibration is often executed upon initially beginning a phosphor dispensing process or any time the viscous material is changed. As will be appreciated, the execution of a dot size calibration is application dependent and can be automatically run at set time intervals, part intervals, with every part, etc. If a dot size calibration is to be run, the computer 48 executes a subroutine at block 128. Suitable such subroutines are discussed below in the text that describes FIGS. 5-7.

Upon completion of the dot size calibration at block 128, the computer 48 then determines at block 130 whether a dot placement calibration is required. A dot placement calibration is often executed upon initially beginning a dot dispensing process and any time the maximum velocity or viscous material changes. As will be appreciated, the execution of a dot placement calibration is application dependent and can be automatically run at set time intervals, part intervals, with every part, etc. The droplet generator 42 is often jetting viscous material droplets 64 on-the-fly, that is, while it is moving relative to the plasma panel 66. Therefore, the viscous material droplets 64 do not vertically drop onto the plasma panel 66, but instead have a horizontal motion component prior to landing on the panel 66. Consequently, the position at which the droplet generator 42 dispenses the material droplet 64 should be offset to compensate for that horizontal displacement of the viscous material droplet 64 prior to landing on the plasma panel 66. To determine this offset, the computer 48 executes at block 132 a dot placement calibration subroutine discussed below in greater detail.

After the various calibration subroutines have been executed, the computer 48 then commands the conveyor controller 96 at block 134 to operate the conveyor 52 and transport the plasma panel 66 to a fixed position within the noncontact jetting system 40. In a known manner, an automatic fiducial recognition system locates fiducials on the substrate and corrects for any misalignment to ensure the plasma panel 66 is accurately placed within the noncontact jetting system 40.

At block 136 of FIG. 4, the computer 48 determines the position coordinates of the first and last dispense points of the phosphor material to be deposited and further applies the offset values determined during the dot placement calibration. As will be appreciated, the offset value may be resolved into X and Y components depending on the orientation of the cells 12 on the panel 66. The computer 48 then determines a distance required to accelerate the droplet generator 42 to a desired velocity. Next, a prestart point is defined that is along the path between the first and last points, but displaced from the first point by the acceleration distance. In a case where multiple jet nozzles are concurrently employed, it may be necessary to align the jet nozzles. Where that is the case at block 138, the computer 48 initiates processes at block 140 to adjust for rotational offset. Such processes may include, for instance, a camera locating two points indicative of the spatial relation between a plasma panel and a line of jetting dispensers.

The computer 48 commands at block 142 the motion controller 92 to move the nozzle 78. Motion is first commanded to the prestart point, and then motion is commanded to the first dispense point as modified by the offset value. Thus, after reaching the prestart point, the nozzle begins moving along a path between the first and last dispense points. The motion controller 92 then determines at block 144 when the nozzle 78 has been moved to the next dispense point, for example, the first dispense point as modified by the offset value. The motion controller 92 then provides at block 146 a command to the droplet generator controller 100 to operate the jetting valve 70 and dispense the first dot of phosphor. Thus, the first dot is jetted at a nozzle location offset from the first dispense position, but due to the relative velocity between the droplet generator 42 and the plasma panel 66, the first dot lands within a cell 12 of the plasma panel 66, i.e., at the desired first dispense position.

Thereafter, the dispensing process iterates through steps 142-146 to dispense the other phosphor dots. With each iteration, the computer 48 provides commands to the motion controller 92, which cause the droplet generator 42 to move through an incremental displacement equal to the dot pitch. Each successive increment of motion equal to dot pitch represents the next dispense point and is detected by the motion controller 92 at block 144. Upon detecting each increment of motion, the motion controller 92 provides at block 146 a command to the droplet generator controller 100. The command causes a droplet of viscous material to be dispensed. Since the first dispense point was modified by the offset values, the positions of the other incrementally determined dispensed points are also modified by the offset values. Therefore, further dots are applied to the plasma panel 66 at the desired points.

The motion controller 92 determines when the last dispense point as modified by the offset value has been reached and provides a command to the droplet generator controller 100 to dispense the last dot. The computer 48 determines at block 148 when all of the phosphor dots have been dispensed to the respective plasma cells 12.

Thus, the application of the offset value causes the dispenser 70 to jet a droplet of phosphor 64 at a position in advance of a position at which dispensing would occur if the dispenser were stationary. However, with the dispenser 70 being moved at the maximum velocity and using an offset value determined by the maximum velocity, by jetting the droplet at an advance position determined by the offset value, the jetted droplet 64 lands on the plasma panel 66 as the dot 12 at its desired location within the cell 12.

It should be noted that in iterating through steps 144-148, a difference exists depending on whether the motion controller 92 is identifying successive dispense points in terms of absolute coordinate values or by the dot pitch. If the motion controller 92 is tracking dot pitch, the offset value is applied to only the first and last dispense points in the line. However, if the motion controller 92 is determining the absolute position values for each of the dispense points, then the offset value is subtracted from the absolute coordinate values for each of the dispense points.

FIG. 5 is a flowchart 160 generally illustrating a phosphor dot size calibration process using the viscous material jetting system of FIG. 2. The sequence of method steps may have particular application in the context of the calibration processes of FIG. 4. Referring more particularly to FIG. 5, the computer 48 executes a dot size calibration that is capable of changing the amount of the dispensed material volume and hence, the dot size, by changing the temperature of the viscous material within the nozzle 78, thereby changing viscosity and flow characteristics. In a first step of this calibration process, the computer 48 commands at block 162 the motion controller 92 to move the droplet generator 42 to the calibration station 56 such that the nozzle 78 is directly over the work surface 74. Next at block 164, the computer 48 commands the motion controller 92 to cause the droplet generator controller 100 to dispense dots 31a, 31b, 31n on the work surface 74.

During this calibration process, the dots 31 are applied at a rate that is to be used in the production dispensing process. The computer 48 then at block 166 commands the motion controller 92 to move the camera 46 along the same path along which the dots 31a, 31b, 31n were applied.

The computer 48 and vision circuit 94 provide a feedback signal representing a size-related physical characteristic of the applied dot, which in this embodiment is a first edge 112 of a first dot; and the computer 48 stores in the computer memory 84 position coordinates of a point on that first edge 112. With continued motion of the camera along the path, another feedback signal is provided representing a diametrically opposite second edge 114 of the first dot 31a; and position coordinates of a point on the second edge 114 of the first dot 31a are also stored in the computer memory 84. The distance between the two sets of position coordinates represents the diameter or size of the first dot 31a. The above process of detecting dot edges and storing respective position coordinates continues for other dots 31b, 31n on the surface 74. A sufficient number of dots are dispensed and measured by the computer 48 so as to provide a statistically reliable measure of dot diameter. However, as will be appreciated, the diameter of a single applied dot may be measured and used to initiate a dot size calibration.

After all of the dots have been deposited and measured at block 166, the computer 48 then determines the average dot diameter or size at block 168, and determines whether the average dot diameter is smaller than a specified dot diameter at block 170. If so, the computer 48 provides at block 172 a command signal to the heater/cooler controller 90 causing the temperature set point to be increased by an incremental amount. The heater/cooler controller 90 then turns on the heater 86 and, by monitoring temperature feedback signals from the thermocouple 88, quickly increases the temperature of the nozzle 78 and the viscous material therein to a temperature equal to the new temperature set point. When the increased temperature has been achieved, the computer 48 provides command signals to the motion controller 92 to cause the droplet generator 100 to again execute the previously described process steps 164-170.

The increased temperature reduces the viscosity of the phosphor material, thereby resulting in more material being dispensed and hence, a larger average volume and dot diameter; and that larger average dot diameter is then compared with the specified dot diameter at 170. If the diameter is still too small, the controller 48 again provides command signals at block 172, to again increase the temperature set point value. The process of steps 164-172 is iterated until the computer 48 determines that the current average dot diameter is equal to, or within an allowable tolerance of, the specified dot diameter.

If the computer 48 determines at block 170 that the average dot diameter is not too small, then the computer determines at block 174 whether the average dot diameter is too large. If so, it provides at block 176 a command signal to the heater/cooler controller 90 that results in a decrease of the temperature set point by an incremental amount. With a reduction in the temperature set point, the heater/cooler controller 90 is operative to turn on the cooler 87. By monitoring the temperature feedback signals from the thermocouple 88, the controller 90 quickly reduces the temperature of the nozzle 78 and the phosphor material therein to the new lower temperature set point value. By reducing the temperature of the viscous material, its viscosity value increases. Therefore, during a subsequent jetting of a number of dots, less phosphor is dispensed, and the computer 48 detects a smaller average volume or dot diameter. Again, the process of steps 164-174 iterates until the average dot diameter is reduced to a value equal to, or within an allowable tolerance of, the specified phosphor dot diameter.

In the dot size calibration process described above, the computer 48 iterates the process by jetting and measuring successive dots until a specified dot diameter is achieved. In an alternative embodiment, a relationship between a change in temperature and a change in dot size for phosphor material can be determined experimentally or otherwise. That relationship can be stored in the computer 48 either as a mathematical algorithm or a table that relates changes in dot size to changes in temperature. Therefore, instead of the iterative process described above, after determining the amount by which the dot diameter is too large or too small, the computer 48 can use a stored algorithm or table at blocks 172 and 176 to determine a change in temperature that is required to provide the desired change in dot size. As such, the temperature may be stored at block 178. Where more than one jet is involved in an operation, different temperatures are stored in association with respective jets. This feature accounts for equipment differences between the jets and helps ensure desired dot size as calibrated for each jet. In still further embodiments, the above-described calibration processes may be executed using radii or circumferences of respective dots that are determined from the edges detected by the camera.

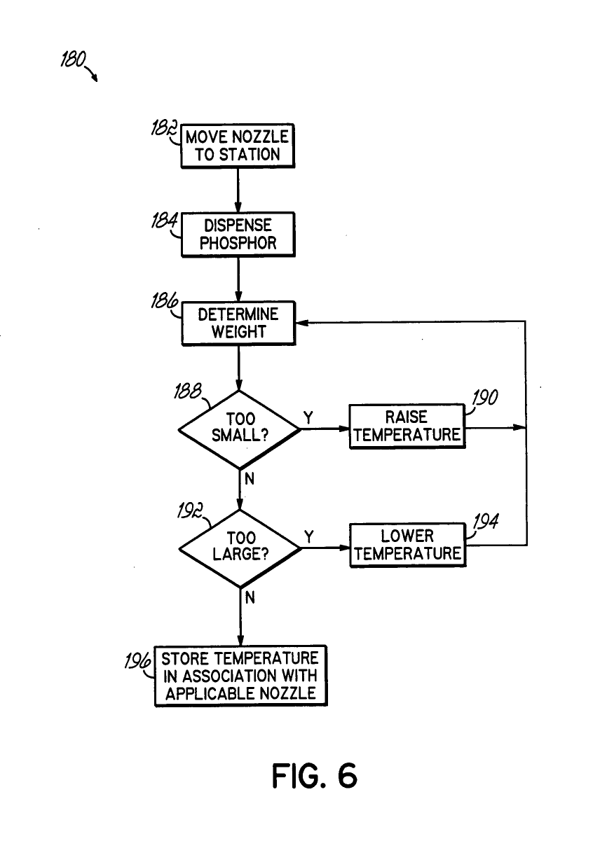

FIG. 5 illustrates one embodiment of a dot size calibration subroutine. As will be appreciated, other embodiments may provide other calibration processes. For example, an alternative dot placement calibration subroutine is illustrated in the flowchart 180 of FIG. 6. As with the calibration process described in FIG. 5, the computer 48 executes a dot size calibration that changes dot size or volume by changing the temperature of the viscous material within the nozzle 78, thereby changing viscous and flow characteristics. However, the process of FIG. 6 use the weigh scale 82 instead of the camera 46 as a measurement device. In a first step of this calibration process, the computer 48 commands at block 182 of FIG. 6 the motion controller 92 to move the droplet generator 42 to the calibration station 56. The generator 42 moves such that the nozzle 78 is directly over the table 76 of the scale 82.

Next at block 184, the computer 48 commands the droplet generator controller 100 to dispense dots onto the table 76. As will be appreciated, a dispensed dot is often not detectable within the resolution range of the weigh scale 82. Therefore, a significant number of dots may have to be dispensed in order to provide a statistically reliable measurement of dispensed material weight by the weigh scale 82. However, if the scale has a sufficiently high resolution, only a single applied dot of phosphor material can be used for the dot size calibration.

At the end of the dispensing process, the computer 48 at block 186 samples a weight feedback signal from the weigh scale 82, which represents the weight of the dispensed dot. The computer 48 then compares at block 188 the dispensed weight to a specified weight stored in the computer memory 84 and determines whether the dispensed weight is less than the specified weight. If so, the computer 48 provides at block 190 a command signal to the heater/cooler controller 90 causing the temperature set point to be increased by an incremental amount. The heater/cooler controller 90 then turns on the heater 86, and by monitoring temperature feedback signals from the thermocouple 88, quickly increases the temperature of the nozzle 78 and the viscous material therein to a temperature equal to the new temperature set point.

When increased temperature has been achieved, the computer 48 provides command signals to the motion controller 92 and droplet generator 100 to again execute the previously described process steps 184-188. The increased temperature reduces the viscosity of the phosphor material, thereby resulting in each dot having a larger volume and weight as well as a larger dot diameter; and that larger weight is again compared with the specified dot diameter at 188. If the dispensed weight is still too small, the controller 48 again provides command signals at block 190 to again increase the temperature set point value. The process of steps 184-190 are iterated until the computer 48 determines that the current dispensed weight is equal to, or within an allowable tolerance of the specified weight.

The computer 48 then determines at block 192 whether the dispensed weight is too large. If so, the computer 48 provides at block 194 a command signal to the heater/cooler controller 90 that results in a decrease of the temperature set point by an incremental amount. With a reduction in the temperature set point, the heater/cooler controller 90 is operative to turn on the cooler 87. By monitoring the temperature feedback signals from the thermocouple 88, the temperature of the nozzle 78 and the viscous phosphor material therein is quickly reduced to a temperature equal to the new lower temperature set point value. By reducing the temperature of the viscous material, its viscosity increases. During a subsequent dispensing operation, each phosphor dot will have less volume and weight, as well as a smaller diameter. The processes of steps 184-194 iterate until the dispensed weight is reduced to a value equal to, or within an allowable tolerance of the specified weight. As in the above-described embodiment, the temperature may be stored in association with a respective jet at block 196 to ensure conformity between different jets operating on a plasma panel 66.

In the dot size calibration process described in FIG. 6, the computer 48 iterates the process by dispensing and measuring dispensed weights until a specified weight is achieved. In an alternative embodiment, a relationship between a change in temperature and a change in dispensed weight for a particular viscous material can be determined experimentally or otherwise. That relationship can be stored in the computer 48 either as a mathematical algorithm or a table that relates changes in dispensed weight to changes in temperature. Therefore, instead of the iterative process described above, after determining the amount by which the dispensed weight is too large or too small, the computer 48 can at block 190 or 194 use a stored algorithm or table to determined a change in temperature that is required to provide the desired change in dispensed weight. After commanding the heater/cooler controller 90 to change the temperature set point by that amount, the process ends.

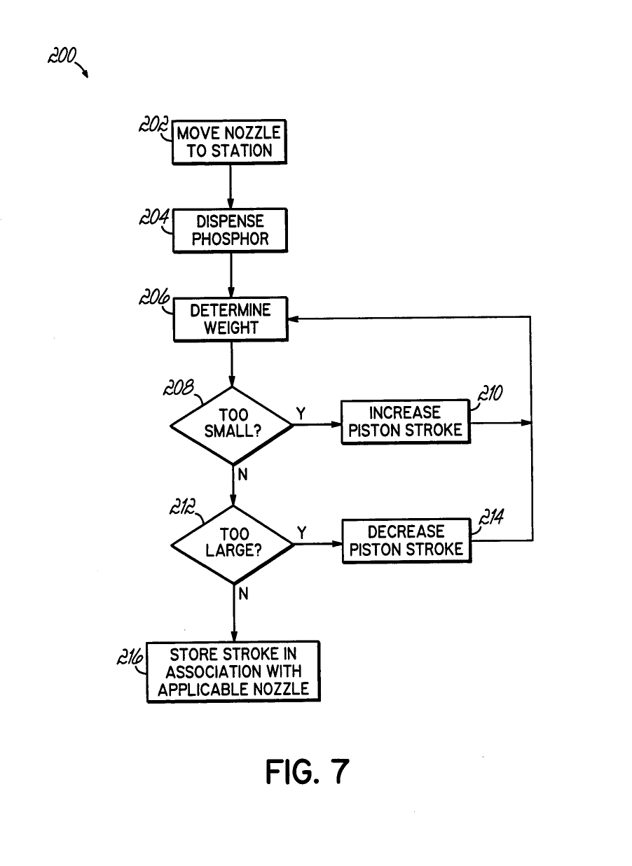

A further alternative embodiment of the dot placement calibration subroutine is illustrated in FIG. 7. As with the calibration process described in FIG. 6, the computer 48 executes a dot size calibration that changes dot size, or volume, based on a feedback signal from the weigh scale 82. However, in the process of FIG. 7, the dot size is adjusted by adjusting the stroke of the piston 71 of the control valve 93 in the dispenser 70. In a first step of this calibration process, the computer 48 commands at block 202 the motion controller 92 to move the droplet generator 42 to the calibration station 56 such that the nozzle 78 is directly over the table of the scale 82. Next at block 204, the computer 48 commands the droplet generator controller 100 to dispense phosphor dots onto the scale. As will be appreciated, a dispensed dot is often not detectable within the resolution range of the weigh scale 82. Therefore, a significant number of dots may have to be dispensed in order to provide a statistically reliable measurement of dispensed material weight by the weigh scale 82. However, if the scale has a sufficiently high resolution, only a single applied dot of phosphor material can be used for the dot size calibration.

At the end of the dispensing process, the computer 48 at block 206 samples a feedback signal from the weigh scale 82, which represents the weight of the dispensed phosphor dot 30. The computer 48 then compares at block 208 the dispensed weight to a specified weight stored in the computer memory 84 and determines whether the dispensed weight is less than the specified weight. If so, the computer 48 provides at block 210 an increase piston stroke command to the droplet generator controller 100. The command causes the controller 100 to operate the motor 91 in a direction to move the micrometer screw 83 vertically upward as viewed in FIG. 3.

The computer 48 then provides command signals to the motion controller 92 and droplet generator 100 to again execute the previously described process steps 204-208. The increased piston stroke results in each dot dispensed having a larger volume and weight, as well as a larger dot diameter. The cumulative larger weight of all of the dispensed phosphor dot is again compared with the specified weight at 208. If the diameter is still too small, the controller 48 again provides an increase piston stroke command signal at block 908 that results in the micrometer screw 83 being moved by the motor 91 further upward. The process of steps 204-210 are iterated until the computer 48 determines that the current dispensed weight is equal to, or within an allowable tolerance of, the specified weight.

If the computer 48 determines at block 208, that the dispensed weight is not too small, it then determines at block 212 whether the dispensed weight is too large. If so, the computer 48 provides at block 214 a decrease piston stroke command signal to the droplet generator controller 100 that results in the motor 91 moving the micrometer screw 83 vertically downward as viewed in FIG. 3. With a smaller piston stroke, during a subsequent dispensing operation, each dot dispensed will have a lesser volume and weight as well as a smaller diameter. Again, the process of steps 204-214 iterates until the dispensed weight is reduced to a value equal to, or within an allowable tolerance of the specified weight.

In the dot size calibration process of FIG. 7, the computer 48 iterates the process by dispensing and measuring dispensed weights until a specified weight is achieved. That relationship can be stored in the computer 48 either as a mathematical algorithm or a table that relates changes in dispensed weight to changes in piston stroke. An algorithm or table can be created and stored for a number of different viscous materials. Therefore, instead of the iterative process described above, after determining the amount by which the dispensed weight is too large or too small, the computer 48 can at block 210 and 214, use a stored algorithm or table to determined a change in piston stroke that is required to provide the desired change in dispensed weight. The dot size calibration process described above can also be executed on a dispensed dot weight basis. Knowing the number of dots dispensed, the computer 48 is then able to determine at block 206, an average weight of each dot dispensed.

As will be appreciated, in another alternative embodiment, in a process similar to that described in FIG. 7, the dispensed weight of the viscous material can also be changed by adjusting the on-time of the pulse applied to the transducer 110 that operates the jetting valve 70. For example at block 210, in response to detecting that the dispensed weight is too small, the computer 48 can command the droplet generator controller 100 to increase the on-time of the signal operating the transducer 110. With the increased on-time, more material is dispensed, thereby increasing the dispensed weight and dot size. Similarly at block step 214, in response to detecting that the dispensed weight is too large, the computer 48 can command the droplet generator controller 100 to decrease the on-time of the signal operating the transducer 110. With the decreased on-time, less material is dispensed, thereby decreasing the dispensed weight and dot size.

The appropriate piston stroke parameter is stored at block 216. Where more than one jet is involved in a phosphor dispensing operation, multiple such parameters are stored in association with each respective jet to account for mechanical variation as between the jets. This feature thus ensures conformity of dot size as between different nozzles and/or jetting dispensers.

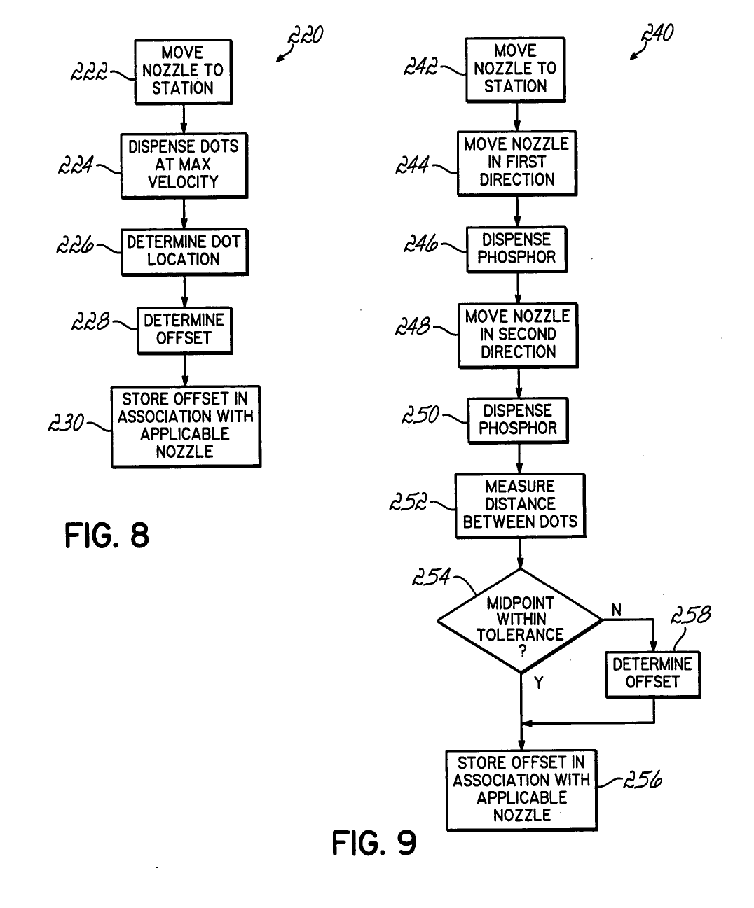

FIG. 8 is a flowchart 220 generally illustrating a dot placement calibration process using the viscous material jetting system of FIG. 2. The placement calibration steps of the flowchart 220 have particular application within the calibration processes of FIG. 4. Turning more particularly to FIG. 8, the computer 48 commands at block 222 the motion controller 92 to cause the droplet generator 42 to move to a location placing the nozzle 78 over the work surface 74 of the calibration station 56. The computer 48 then commands at block 224 the motion controller 92 to cause the droplet generator controller 100 to dispense phosphor dots onto the work surface 74. Thereafter, the computer 48 commands at block 226 the motion controller 92 to move the camera 46 along the same path over which the dots were dispensed.

In a manner as previously described, the computer 48 and vision circuit 94 detect diametrically opposed edges of the dots, and the computer 48 stores coordinate values of points on the edges. Based on those stored points, the computer determines position coordinates of a center of the dots. The computer 48 then determines at block 228 a difference between a position of the nozzle 78 when a droplet 64 was ejected and a position of a respective dot 31 on the work surface 74. The difference in those two positions is stored as an offset value in the computer memory 84.

In use, the dot size and placement calibrations are performed at various times depending on the customer specifications, the type of viscous material used, application requirements, etc. For example, all three calibrations are performed upon initially beginning a dot dispensing process for a group of parts, for example, while parts are being loaded and unloaded from the machine. In addition, all three processes are executed any time the viscous material is changed. Further, the calibrations can be automatically run at set time intervals, part intervals or with every part. It should also be noted that if the dispensed weight, dot diameter or dot size changes, the material volume calibration should be re-executed to obtain a new maximum velocity; and further, if the maximum velocity changes, the dot placement calibration should be re-executed to obtain a new offset value.

Dot size calibrations can also be performed to provide a calibration table 113 in the memory 84 of the computer 48. The calibration table 113 stores a range of dot sizes that have been calibrated to respective operating parameters, for example, temperature, the stroke of the piston 71 and/or the on-time of the pulse operating the transducer 110, etc. Thus, the calibration table 113 relates a particular dot size to a temperature and/or piston stroke and/or operating pulse width. Further, based on those stored calibrations, the dot size can be changed in real time during a dot dispensing cycle to meet different application demands by appropriately adjusting the piston stroke or operating pulse width as required. Since the various material volumes are known in advance, in one embodiment, the selection of desired dot sizes from the calibration table 113 can be programmed in advance.

Although dots of one size are most often dispensed over an area of the test substrate to achieve the desired material volume, in an alternative application, the desired material volume may be more accurately achieved by dispensing dots of a first size over the area and then dispensing dots of a second size over the same area. Thus, piston strokes or operating pulse on-times corresponding to the respective first and second size dots can be read from the calibration table and appropriate adjustments made between dot dispensing cycles.

As will be appreciated, the same parameter does not have to be used with the selection of each dot size. For example, some dot sizes may practically be more accurately or easily achieved with a piston stroke adjustment, and other dot sizes may be more readily achieved with an operating on-time pulse adjustment. The choice of which parameter to use will be determined by the capabilities and characteristics of the dispensing jet, as well as of the dispensed phosphor and other application related factors. As will further be appreciated, temperature can also be used to adjust dot sizes in a dot dispensing process, but the longer response time required to achieve a dot size change resulting from a temperature change makes the use of temperature less practical.

The noncontact jetting system 40 more accurately applies on-the-fly, viscous phosphor material dots on a plasma panel 66. First, the noncontact jetting system 40 has a temperature controller 116 that includes separate devices 86, 87 for, respectively, increasing and decreasing the temperature of the nozzle 78, so that the temperature of the viscous material is accurately controlled while it is in the nozzle 78. Second, the ability to actively heat or cool the nozzle permits the dispensed volume or dot size to be adjusted by changing the temperature of the nozzle 78. Further, as will subsequently be described, the dispensed volume or dot size can be changed by adjusting the stroke of the piston 71 or the on-time of the pulse operating the transducer 110. This has an advantage of a simpler and less expensive system with a faster response time for calibrating dot size.

Further, the noncontact jetting system 40 permits a relative velocity between the nozzle 78 and the plasma panel 66 to be automatically optimized as a function of the viscous material dispensing characteristics and a specified total volume of material to be used on the substrate. Further, the maximum velocity can be automatically and periodically re-calibrated with the advantage of providing a more accurate dispensing a desired total amount of viscous material on the substrate. In addition, the noncontact jetting system 40 optimizes the positions at which respective dots are to be dispensed on-the-fly as a function of the relative velocity between the nozzle and the substrate. Thus, a further advantage is that viscous material dots are accurately and efficiently located on the plasma panel.

FIG. 9 illustrates another embodiment of a dot placement calibration subroutine. In this calibration process, the computer 48 first at block 242 commands the motion controller 92 to move the droplet generator 42 to position the nozzle 78 over the work surface 74. Thereafter, the computer 48 commands at block 244 the motion controller 92 to move the droplet generator 42 at a constant velocity in a first direction. Simultaneously, the computer 48 commands at block 246 the droplet generator controller 100 to operate the jetting valve 70 and apply a viscous material dot at a reference position. Next, the computer 48 commands at block 248 the motion controller 92 to move the droplet generator 42 at the constant velocity in an opposite direction. The computer 48 simultaneously commands at block 250 the droplet generator controller 100 to apply a dot of viscous material at the reference position. The result is that two dots of viscous phosphor material are applied to the work surface 74. With all conditions being substantially the same during the two jetting processes, the midpoint between the dots should be located at the reference position.

Next, the computer 48 commands at block 252 the motion controller to move the camera over the two dots, that is, along the same path used to apply the dots. During that motion, the computer 48 and vision circuit 94 are able to monitor the image from the camera 46 and determine coordinate values for diametrically opposite points on the respective edges of each of the dots. Given those points, the computer 48 can then determine the distance between the phosphor dots and a midpoint between the dots. The computer 48 then determines at block 254, whether the midpoint is located within a specified tolerance of the reference position. If not, the computer 48 is then able to determine and store an offset value at block 258.

The offset value should be substantially equal to one-half of the measured distance between the dots. To confirm the accuracy of the offset value, the steps 244-254 can be repeated. However, at steps 246 and 250, the position at which the computer 48 commands the droplet generator controller 100 to jet a droplet is offset by the value determined at step 258. If the computer 48 determines at block 254, that the distance is still not within the tolerance, the process of steps 244-258 are repeated until an offset value providing an acceptable distance is determined. Alternatively, if there is a higher level of confidence in the dot placement calibration subroutine, after determining and storing the offset value at 258, the process can simply return to the operating cycle of FIG. 4.

In an alternative embodiment, knowing the velocity of the droplet generator 42 and the distance between the dots, the computer 48 can determine a time advance offset. That is, the increment of time that the ejection of the viscous material droplet 64 should be advanced prior to the droplet generator 42 reaching the reference position.

While the invention has been illustrated by a description of several embodiments and while those embodiments have been described in considerable detail, there is no intention to restrict, or in any way limit the scope of the appended claims to such detail. Additional advantages and modifications will readily appear to those who are skilled in the art. For example, calibration routines are described as jetting dots of viscous material onto the stationary surface 74. However, as will be appreciated, in alternative embodiments, the calibration cycles can be executed by jetting viscous material dots onto the plasma panel 66.

Moreover, while an embodiment of the present invention has particular application in the context of plasma panels, one skilled in the art will appreciate the principles of the present invention may apply equally to the manufacture of other types of optical displays, including LED arrays and associated wafer level packages. A “cell” in the context of other such optical panel application may comprise a cavity, aperture or other array element. While the light emitting fluid discussed above regards a phosphor containing material, one skilled in the art will appreciate that other light inducing substances may be used alternatively in accordance with the principles of the present invention. Therefore, the invention in its broadest aspects is not limited to the specific details shown and described. Consequently, departures may be made from the details described herein without departing from the spirit and scope of the claims that follow.

What is claimed is:

1. A jetting system configured to apply a dot of light emitting material within a cell of an optical display panel, the system comprising:
a jetting dispenser having a nozzle and a piston mounted for reciprocation with respect to a seat, the jetting dispenser adapted to be connected to a source of light emitting material and mounted for relative motion with respect to a surface;
a control operatively connected to the jetting dispenser and having a memory for storing a desired dot size value representing a desired size of a dot of the light emitting material to be applied to the surface, the control being operable to command the piston to move through a stroke away from a seat and the piston being movable through the stroke toward the seat to jet a droplet of the light emitting material through the nozzle, which is applied to the surface as a dot;
a device connected to the control and providing a feedback signal to the control representing a size-related physical characteristic of the dot applied to the surface; and
the control being operable to change the stroke of the piston in response to the feedback signal representing a size-related physical characteristic of the dot applied to the surface being different from the desired dot size value.

2. The jetting system of claim 1 further comprising a fluid regulator configured to regulate flow of the light emitting material from the source.

3. The jetting system of claim 1 further comprising an additional nozzle and an additional piston operatively connected to the control, wherein the control is operable to change the stroke of the piston.

4. The jetting system of claim 3 wherein the jetting dispenser includes the additional nozzle.

5. The jetting system of claim 3 wherein the control is operable to coordinate jetting processes between both nozzles.

6. The jetting system of claim 1 wherein the size-related physical characteristic is determinative of a diameter of the dot applied to the surface.

7. The jetting system of claim 1 wherein the size-related physical characteristic is determinative of a weight of the dot applied to the surface.

8. The jetting system of claim 1 wherein the device is at least one of a camera and a weigh scale.

9. A jetting system configured to apply a dot of light emitting material within a cell of an optical display panel, the system comprising:
a jetting dispenser having a nozzle adapted to be connected to a source of the light emitting material, the jetting dispenser being mounted for relative motion with respect to the surface;
a control operatively connected to the jetting dispenser and having a memory for storing a desired size-related physical characteristic of a dot of the light emitting material to be applied to the surface, the control being operable to command the jetting dispenser to apply dots of the light emitting material onto the surface;
a device connected to the control and providing a feedback signal to the control representing a detected size-related physical characteristic of the dot applied to the surface; and
a temperature controller comprising a first device for increasing the temperature of the nozzle and a second device for decreasing the temperature of the nozzle, the control being operable to cause the temperature controller to change a temperature of the nozzle in response to a difference between the detected size-related physical characteristic and the desired size-related physical characteristic.

10. The jetting system of claim 9 wherein the size-related physical characteristic is determinative of a diameter of the dot applied to the surface.

11. The jetting system of claim 9 wherein the size-related physical characteristic is determinative of a weight of the dot applied to the surface.

12. The jetting system of claim 9 further comprising a regulator configured to control flow of the light emitting material from the source.

13. The jetting system of claim 9 wherein the temperature controller comprises:
a heater connected to the control, the control being operable to cause the heater to heat the nozzle in response to the detected size-related physical characteristic being less than the desired size-related physical characteristic; and
a cooler connected to the control, the control being operable to cause the cooler to cool the nozzle in response to the detected size-related physical characteristic being greater than the desired size-related physical characteristic.

14. A jetting system configured to apply a dot of light emitting material within a cell of an optical display panel, the system comprising:
a jetting dispenser having a nozzle adapted to be connected to a source of light emitting material, the jetting dispenser being mounted for relative motion with respect to a surface;
a control operatively connected to the jetting dispenser and being operable to command the jetting dispenser to apply a dot of the light emitting material to the surface;
a device connected to the control and providing a feedback signal to the control representing a detected weight of the dot applied to the surface; and
a temperature controller operable to increase or decrease a temperature of the nozzle, the control being operable to cause the temperature controller to change the temperature of the nozzle in response to the detected weight of the dot applied to the surface being different from a desired value.

15. A jetting system configured to apply a dot of light emitting material within a cell of an optical display panel, the system comprising:
a jetting dispenser having a nozzle and a piston mounted for reciprocation with respect to a seat, the jetting dispenser adapted to be connected to a source of light emitting material and mounted for relative motion with respect to a surface; and
a control operatively connected to the jetting dispenser and having a memory for storing a table with values relating dot sizes to respective operating parameters, each operating parameter causing the jetting dispenser to dispense a respective dot size of the light emitting material on the surface, the control being operable to command the piston to move through a stroke away from a seat and the piston being movable through the stroke toward the seat to jet a droplet of the light emitting material through the nozzle, which is applied to the surface as a dot of the light emitting material.

16. The jetting system of claim 15 wherein the operating parameter is at least one of temperature, stroke of the piston and operating pulse on-time.

17. A jetting system configured to apply a dot of light emitting material within a cell of an optical display panel, the system comprising:
a jetting dispenser having a nozzle and adapted to be connected to a source of light emitting material, the jetting dispenser being mounted for relative motion with respect to a surface;
a control operatively connected to the jetting dispenser and having a memory for storing an offset value, the control operating the jetting dispenser at a first location to apply a dot of the light emitting material onto the surface;
a camera connected to the control and providing a feedback signal to the control representing a location of a physical characteristic of the dot on the surface, wherein the control is operable to determine a location of the dot on the surface and then, to determine an offset value representing a difference between the first location and the location of the physical characteristic dot on the surface.

18. A method of operating a jetting dispenser having a nozzle configured to apply a dot of light emitting fluid within a cell of an optical display panel, the method comprising:
operating the jetting dispenser to apply a dot of light emitting material onto a surface;
determining a size-related physical characteristic of the dot applied to the surface; and
operating at least one of a first device that increases the temperature of the nozzle and a second device that decreases the temperature of the nozzle in response to the size-related physical characteristic of the dot applied to the surface deviating from a desired value.

19. The method of claim 18 wherein operating the jetting dispenser further includes applying a dot comprising phosphor.

20. The method of claim 18 wherein operating the jetting dispenser further includes applying the dot onto the surface comprising at least one of a test substrate and the cell.

21. The method of claim 18 wherein the size-related physical characteristic is determinative of a weight of the dot applied to the surface.

22. The method of claim 18 further comprising:
increasing the temperature of the nozzle of the jetting dispenser with a first device in response to the size-related physical characteristic of the dots applied to the surface being less than the desired value; and
decreasing the temperature the nozzle of the jetting dispenser with a second device in response to the size-related physical characteristic of the dots applied to the surface being greater than the desired value.

23. A method of operating a jetting system configured to apply a dot of light emitting fluid within a cell of an optical display panel, the method comprising:
providing a desired size-related physical characteristic of a dot of light emitting material to be applied to a surface;
causing relative motion between a dispenser and the surface;
operating the dispenser to apply a dot of light emitting material onto the surface;
generating feedback signals representing a detected size-related physical characteristic of the dot on the surface; and
operating at least one of a first device that increases the temperature of the nozzle and a second device that decreases the temperature of the nozzle in response to the detected size-related physical characteristic being different from the desired size-related physical characteristic.

24. The method of claim 23 wherein the size-related physical characteristic is determinative of a diameter of the dot on the surface.

25. The method of claim 23 wherein the size-related physical characteristic is determinative of a weight of the dot on the surface.

26. A method of operating a jetting dispenser having a nozzle configured to apply a dot of light emitting fluid within a cell of an optical display panel, the method comprising:
operating the dispenser to apply a dot of light emitting material onto a surface;
determining a weight of the dot applied to the surface; and
changing the temperature of the nozzle in response to the weight of the dot applied to the surface deviating from a desired value.

27. A method of dispensing a light emitting material onto a surface with a jetting dispenser having a piston mounted for reciprocation with respect to a seat, the method comprising:
providing a desired size-related physical characteristic value representing a desired size-related physical characteristic of a dot of light emitting material to be applied to the surface;
causing relative motion between the jetting dispenser and the surface;
applying a dot of the light emitting material to the surface by iteratively withdrawing the piston through a stroke away from the seat and then moving the piston through the stroke toward the seat to jet the drop through the nozzle;
generating a feedback signal to the control representing a size-related physical characteristic of the dot applied to the surface; and
changing the stroke of the piston in response to the feedback signal representing an average size-related physical characteristic different from the desired size-related physical characteristic value.

28. The method of claim 27 wherein the size-related physical characteristic is determinative of a diameter of the dot applied to the surface.

29. The method of claim 27 wherein the size-related physical characteristic is determinative of a weight of the dot applied to the surface.

30. A method of dispensing light emitting material for use in an optical panel onto a surface with a jetting dispenser having a piston mounted for reciprocation with respect to a seat, the method comprising:
withdrawing the piston through a stroke away from the seat;
moving the piston through the stroke toward the seat to jet a drop of light emitting material through the nozzle and onto the surface;
determining a physical characteristic of the dot applied to the surface;
adjusting the stroke of the piston in response to the physical characteristic being different than a desired value; and
iterating the steps of withdrawing, moving, determining and adjusting the stroke of the piston to apply a plurality of dots to the surface and maintain the physical characteristic of the plurality of dots close to the desired value.

31. The method of claim 30 where adjusting the stroke further includes increasing the stroke in response to the physical characteristic being greater than the desired value.

32. The method of claim 30 where adjusting the stroke further includes decreasing the stroke in response to the physical characteristic being less than the desired value.

33. A method of operating a jetting system configured to apply a dot of light emitting fluid within a cell of an optical display panel, the method comprising:
providing first coordinate values representing a position of the jetting dispenser at which the jetting dispenser is operable to apply a dot of light emitting material onto a surface;
moving the jetting dispenser at a relative velocity with respect to the surface;
operating the dispenser to apply a light emitting material dot onto the surface;
detecting the light emitting material dot with a camera;
generating a feedback signal representing a location of a physical characteristic of the light emitting material dot on the surface;
determining second coordinate values representing a position of the light emitting material dot on the surface; and
determining an offset value representing a difference between the first coordinate values and the second coordinate values, the offset value being used to modify the first coordinate values during a subsequent application of a dot onto the surface.

34. A method of operating a jetting system configured to apply a dot of light emitting fluid within a cell of an optical display panel, the method comprising:
moving a jetting dispenser at a relative velocity with respect to a surface;
operating the jetting dispenser to dispense a light emitting material dot onto the surface;
storing first coordinate values representing a position of the jetting dispenser upon operating the jetting dispenser;
storing second coordinate values representing a position of the light emitting material dot on the surface; and
determining an offset value representing a difference between the first coordinate values and the second coordinate values, the offset value being used to modify the first coordinate values during a subsequent operation of the jetting dispenser.

35. A method of operating a jetting system configured to apply a dot of light emitting fluid within a cell of an optical display panel, the method comprising:
moving a jetting dispenser at a first velocity in a first direction with respect to the surface;
operating the jetting dispenser at a first position with respect to the surface to apply a first light emitting material dot onto the surface;
moving the jetting dispenser at a second velocity in a second direction with respect to the surface;
operating the jetting dispenser at a second position with respect to the surface to apply a second light emitting material dot to the surface;
determining a distance between the first dot and the second dot; and
determining an offset value for the first relative position.

36. The method of claim 35 wherein the second direction is opposite the first direction.

37. The method of claim 35 wherein the first relative velocity is equal to the second relative velocity.
